(19) United States
(12) Patent Application Publication
(10) Pub. No.: US 2026/0296293 A1
(43) Pub. Date: Oct. 1, 2026

(54) LOADING SYSTEM FOR VEHICLE TRUNK COMPARTMENT

(71) Applicant: PEGGY F. WESLEY, FORT PIERCE, FL (US)

(72) Inventor: PEGGY F. WESLEY, FORT PIERCE, FL (US)

(21) Appl. No.: 19/574,924

(22) Filed: Mar. 23, 2026

Related U.S. Application Data
(60) Provisional application No. 63/780,581, filed on Mar. 31, 2025.

(51) Int. Cl. B60P 1/44

(52) U.S. Cl. CPC B60P 1/4435; B60P 1/4442

(57) ABSTRACT

A loading system for a vehicle trunk compartment includes a housing configured for installation within the trunk compartment and a loading platform supported relative to the housing. A pair of platform moving assemblies positioned on opposite sides of the loading platform guide movement of the platform between stored and extended positions. The loading system further includes a drive mechanism configured to extend the loading platform outward from the trunk compartment and a vertically adjustable support mechanism configured to lower the loading platform to a position outside and below a trunk opening to facilitate loading and unloading of cargo. The loading platform is movable between a stored configuration inside the trunk compartment, an extended configuration outside the trunk compartment, and a lowered configuration for receiving cargo.

### RELATED APPLICATION

This application claims the benefit of U.S. Provisional Patent Application No. 63/780,581, filed Mar. 31, 2025. The entire disclosure of the above-identified provisional patent application is incorporated by reference herein in its entirety as if fully set forth herein.

### BACKGROUND

### Field

The present invention relates generally to vehicle cargo handling devices and, more particularly, to a loading system installable in a vehicle trunk compartment that includes a movable loading platform capable of extending outward from the trunk and lowering to facilitate loading and unloading of cargo.

### Background Information

Loading heavy luggage or cargo into the trunk of a vehicle often requires a user to lift the cargo upward over the trunk threshold and reach inward to place the cargo onto the trunk floor. This action can require significant physical effort and can create strain on the back, shoulders, and arms of the user. Such lifting motions may be particularly difficult for elderly individuals, persons with reduced mobility or strength, or travelers handling large or heavy suitcases.

In many vehicles, the trunk floor is positioned significantly above ground level. In sport utility vehicles (SUVs), vans, and crossover vehicles, the cargo floor may be even higher. As a result, the user must lift luggage not only vertically but also extend the arms forward into the cargo compartment while leaning over the bumper or rear panel of the vehicle. This motion can be awkward and potentially hazardous, especially when handling large or heavy items.

Various devices have been proposed to assist with loading cargo into vehicles. Some systems include manual sliding platforms or collapsible trays that extend outward from the trunk to provide temporary support for cargo. Other solutions involve external lifts or hoists designed primarily for specialized applications such as wheelchair loading systems. However, many of these systems are not integrated into the vehicle structure, require manual operation, occupy valuable cargo space, or lack convenient automated operation.

Additionally, many known cargo-loading solutions remain visible or protruding when not in use, which can reduce available trunk volume or negatively affect vehicle aesthetics. Other solutions require extensive manual manipulation, which diminishes their usefulness for individuals seeking convenient or automated assistance.

Accordingly, there remains a need for a vehicle cargo loading system that is integrated within the vehicle structure, remains concealed when not in use, and allows cargo to be lowered to a convenient loading position near ground level and then automatically lifted and transferred into the vehicle cargo compartment with minimal effort from the user.

It is therefore an object of the present invention to provide a loading system that facilitates loading and unloading of cargo into a vehicle trunk compartment.

Another object is to provide a loading platform that may extend outward from the trunk compartment.

Another object is to provide a loading platform that may be lowered below the trunk opening to reduce lifting effort.

Another object is to provide a loading system powered by electric motors to provide controlled movement of the loading platform.

Another object is to provide a loading system that can be installed within existing vehicles with minimal structural modification.

### SUMMARY

The present invention provides a loading system configured for installation within a trunk compartment of a vehicle for facilitating loading and unloading of cargo. The system generally includes a housing configured to be mounted within the trunk compartment and a loading platform supported relative to the housing. The loading platform is movable between a stored configuration within the trunk compartment, an extended configuration outside the trunk compartment, and a lowered configuration positioned below the trunk opening to facilitate placement of cargo onto the platform.

In one aspect of the invention, the loading platform is supported and guided by a pair of platform moving assemblies positioned on opposite sides of the loading platform. Each platform moving assembly includes a stationary rail secured relative to the housing and a movable rail configured to slide relative to the stationary rail. Movement of the movable rails relative to the stationary rails allows the loading platform to extend outward from the trunk compartment and retract back into the housing.

In certain embodiments, at least one motor is provided to drive extension and retraction of the movable rails. The motor may be operatively connected to a lead screw through a pulley and belt transmission system. Rotation of the lead screw drives movement of associated components that control extension of the movable rails and operation of a lowering mechanism associated with the loading platform.

The loading system further includes a vertically adjustable support or lowering mechanism connected to the loading platform. In one embodiment, the lowering mechanism includes cables or wires connected to the loading platform and wound around sleeves driven by lead screws. Rotation of the lead screws causes the cables to wind or unwind, thereby raising or lowering the loading platform relative to the housing.

Guide elements positioned along the platform moving assemblies may guide the cables during operation of the lowering mechanism, and cross members extending between the movable rails may support and stabilize the loading platform during extension, lowering, and raising operations.

In certain embodiments, the loading system may include a solenoid-actuated clutch associated with the lead screw drive mechanism to selectively engage or disengage rotational motion used to raise or lower the loading platform. A controller may also be provided to control operation of the motors and coordinate extension, lowering, raising, and retraction of the loading platform.

In operation, the loading platform may first be extended outward from the trunk compartment by sliding the movable rails relative to the stationary rails. Once extended, the lowering mechanism may be actuated to lower the loading platform to a position outside and below the trunk opening, allowing cargo to be placed on the platform with minimal lifting by the user. After cargo has been placed on the platform, the lowering mechanism may raise the platform, and the movable rails may retract the loading platform back into the trunk compartment.

The invention also provides a method for loading cargo into a vehicle trunk compartment. The method includes extending a loading platform outward from a housing installed within the trunk compartment, lowering the loading platform to a position outside and below the trunk opening, placing cargo onto the loading platform, raising the loading platform, and retracting the loading platform back into the trunk compartment.

These and other features and advantages of the invention will become apparent from the following detailed description and the accompanying drawings.

### BRIEF DESCRIPTION OF THE DRAWINGS

The accompanying drawings are included to provide a further understanding of the present invention and are incorporated in and constitute a part of this specification. The drawings illustrate various embodiments of the loading system for a vehicle trunk compartment of the present invention and, along with associated components and together with the description, serve to explain the principles, structure, and operation of the invention. It will be understood that the drawings are schematic in nature and are not necessarily drawn to scale, and that certain features may be exaggerated or simplified for clarity of illustration. Like reference numerals are used to designate corresponding or similar elements throughout the drawings.

FIG. 1 is a perspective view of a loading system for a vehicle trunk compartment (hereinafter also referred to as “loading system”), according to an embodiment of the invention. The loading system is illustrated installed in the trunk of a vehicle compartment in an undeployed state (“first configuration”).

FIG. 2 is a perspective view similar to FIG. 1, illustrating the loading system in a partially deployed state (“second configuration”).

FIG. 3 is a perspective view similar to FIGS. 1 and 2, illustrating the loading system in a fully deployed state (“third configuration”) .

FIG. 4 is a right-side view of the loading system in FIG. 3.

FIG. 5 is a front view of the loading system in FIG. 3.

FIG. 6 is a top view of the loading system in FIG. 3.

FIG. 7 is a perspective view of the loading system which has been removed from the trunk of a vehicle compartment. The loading system is illustrated in the first configuration.

FIG. 8 is a top view of the loading system in FIG. 7.

FIG. 9 is a front view of the loading system in FIG. 7.

FIG. 10 is a rear view of the loading system in FIG. 7.

FIG. 11 is a side view of the loading system in FIG. 7.

FIG. 12A is a bottom view of the loading system in FIG. 7. A bottom cover of the loading system housing is shown removed from the housing to illustrate components of the loading system.

FIG. 12B is a bottom view of the loading system in FIG. 7. The bottom cover of the loading system is shown mounted to the housing.

FIG. 13 is a perspective view similar to FIG. 7, illustrating the loading system in the second configuration.

FIG. 14 is a perspective view similar to FIG. 13, illustrating the loading system in the third configuration.

FIG. 15 is a perspective view similar to FIG. 7, with the housing removed to illustrate components of the loading system. The loading system is illustrated in the first configuration.

FIG. 16 is a perspective view similar to FIG. 15, illustrating the loading system in the second configuration.

FIG. 17 is a perspective view similar to FIG. 16, illustrating the loading system in the third configuration.

FIG. 18 is a front view of the loading system shown in FIG. 14.

FIG. 19 is a side view of the loading system shown in FIG. 14.

FIG. 20 is a bottom view of the loading system shown in FIG. 14.

FIG. 21 is a partial exploded view in perspective of the loading system according to the embodiment of the invention.

FIG. 22 is an exploded view of the right-side sliding assembly of the loading system in FIG. 21.

FIG. 23 is an exploded view of the left-side sliding assembly of the loading system in FIG. 21.

FIG. 24A is a perspective view of the movable rail used in each sliding assembly of the loading system.

FIG. 24B is a cross-sectional view taken along the line A-A in FIG. 24A.

FIG. 25 is a perspective view illustrating the structure of the bottom cover and hardware for mounting the loading system in a vehicle trunk compartment.

FIG. 26 is an exploded view in perspective illustrating the loading system positioned over the bottom cover in FIG. 25 as an example for mounting the loading assembly in a vehicle trunk compartment. The loading platform is omitted from this figure for ease of illustration purposes only.

### DETAILED DESCRIPTION

The present disclosure now will be described more fully hereinafter with reference to the accompanying drawings, in which exemplary aspects and embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art.

Unless expressly stated otherwise, the use of the singular includes the plural and vice versa. Directional or relational terms such as “inner,” “outer,” “inside,” “outside,” “above,” “below,” “upper,” “lower,” “forward,” “rearward,” “inward,” and “outward,” as well as similar terms used to describe movement of the loading platform relative to the housing or trunk compartment, are used solely for convenience in describing the illustrated embodiments and are not intended to limit the invention to any particular orientation, vehicle configuration, or direction of movement. Those skilled in the art will recognize that equivalent components, assemblies, or operational steps may be substituted for those specifically described, and that certain features of the loading system may be used independently of other features without departing from the scope of the invention as defined by the appended claims.

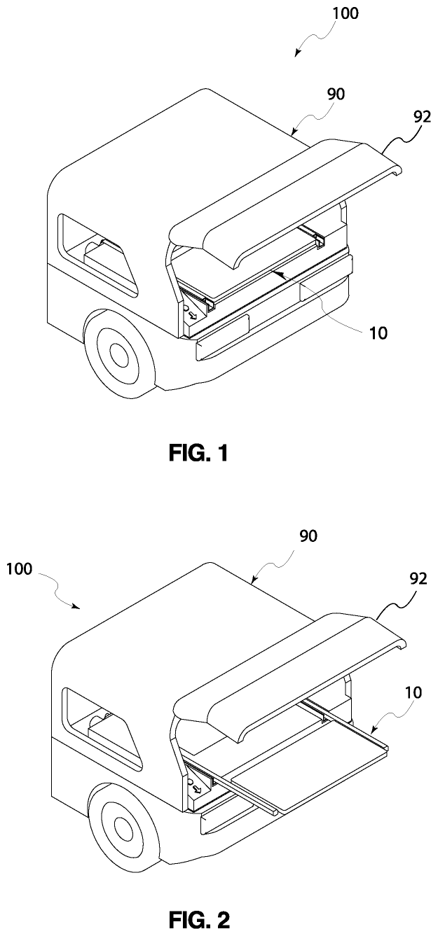

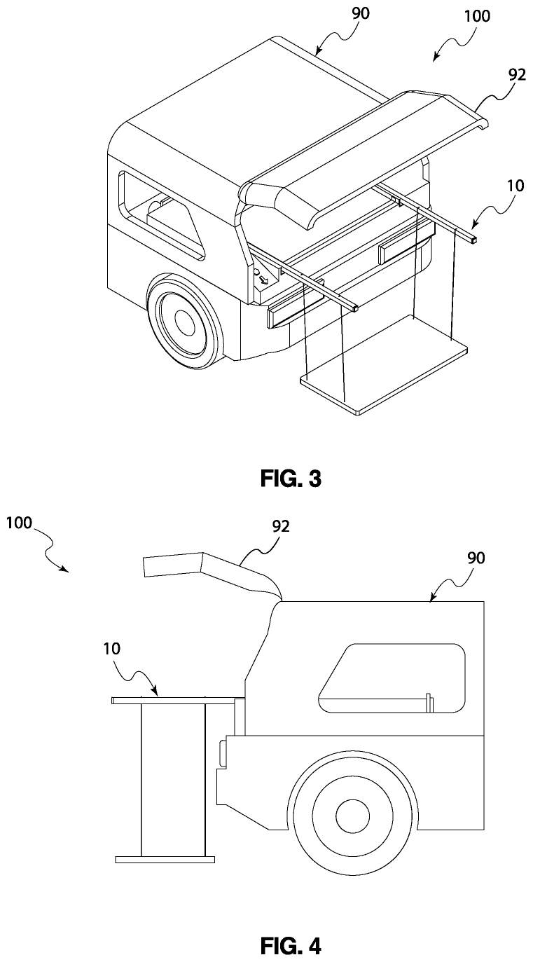

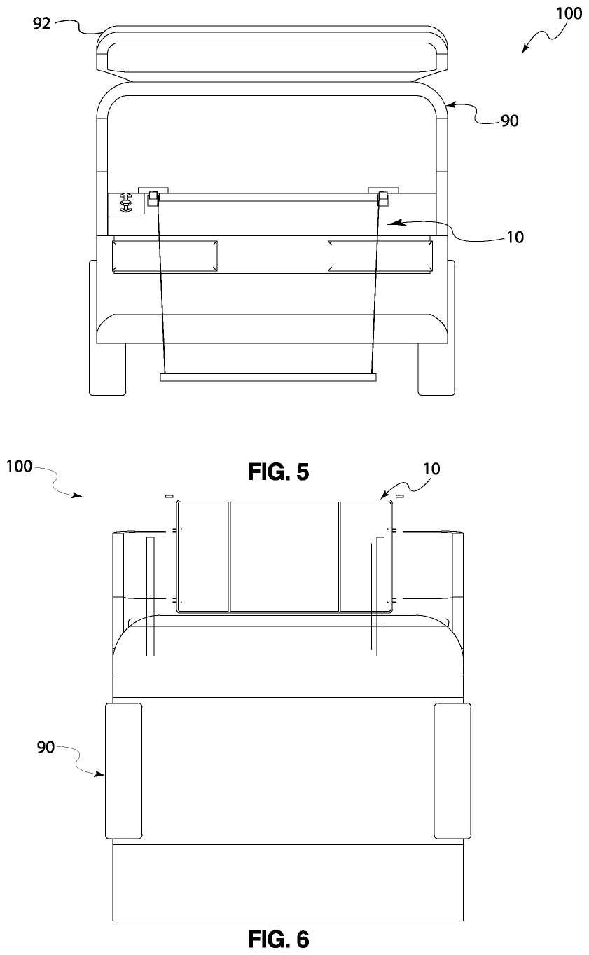

Referring now to the drawings, and particularly to FIGS. 1-6, a loading system 10 according to an embodiment of the invention is configured for installation within the trunk compartment 92 of an automobile 90. The loading system 10 is illustrated as part of a combination 100 including the automobile 90 and the loading system 10 mounted within the trunk compartment 92. The loading system is capable of moving between a stored configuration within the trunk compartment (FIG. 1), an extended configuration in which a loading platform extends outward from the trunk compartment (FIG. 2), and a lowered configuration in which the loading platform is positioned below the trunk opening to facilitate loading cargo (FIGS. 3-6).

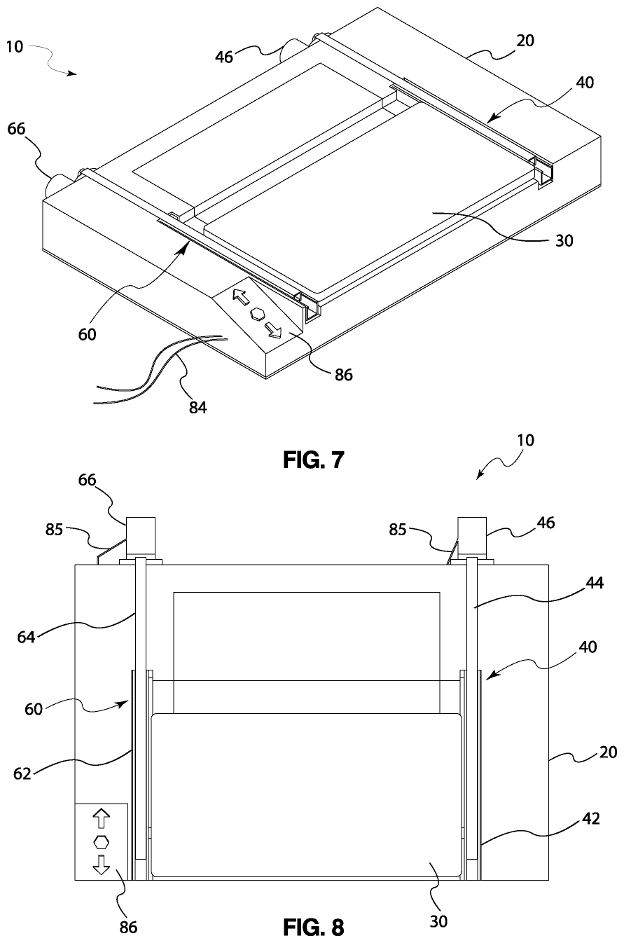

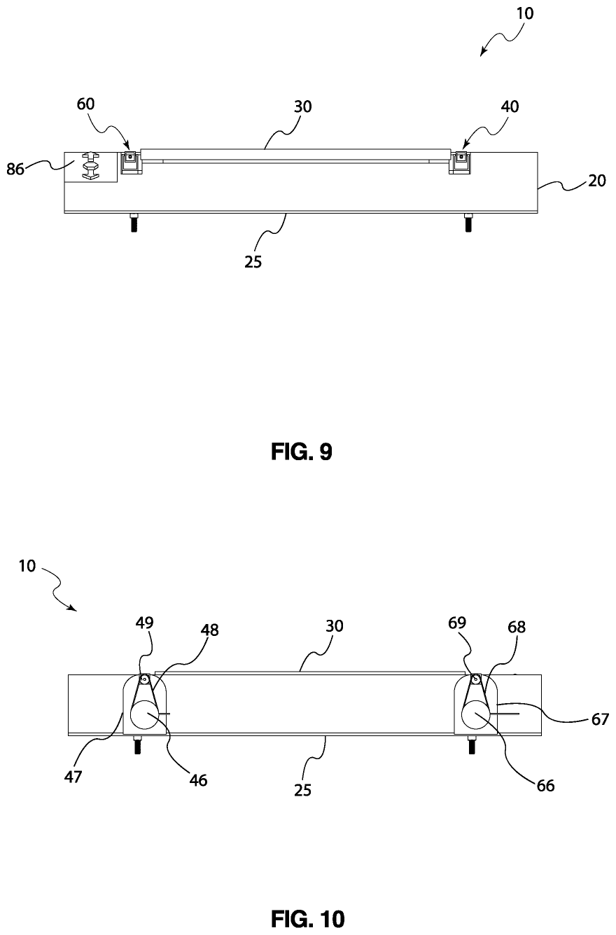

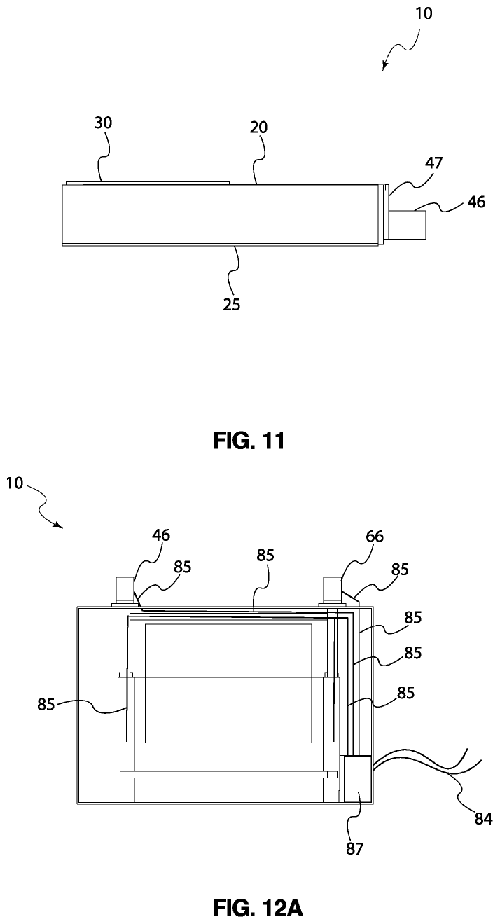

As shown in FIGS. 7-11, the loading system 10 generally includes a housing 20, a loading platform 30, a right-side platform moving assembly 40, and a left-side platform moving assembly 60. The housing 20 encloses various mechanical and electrical components of the loading system and supports the loading platform 30 during operation.

Referring particularly to FIGS. 7-11, the housing 20 forms a structural frame for supporting the components of the loading system. The housing includes channels 20a configured to receive movable rails associated with the platform moving assemblies described below.

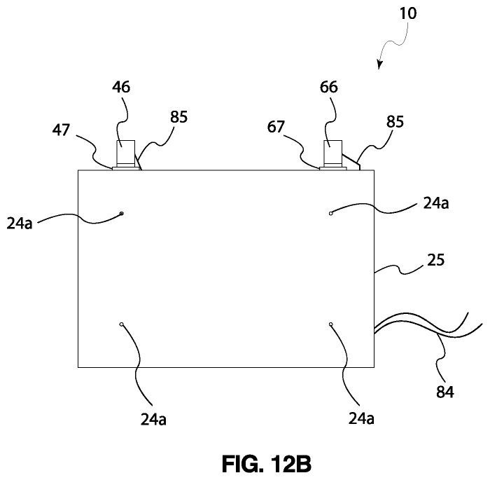

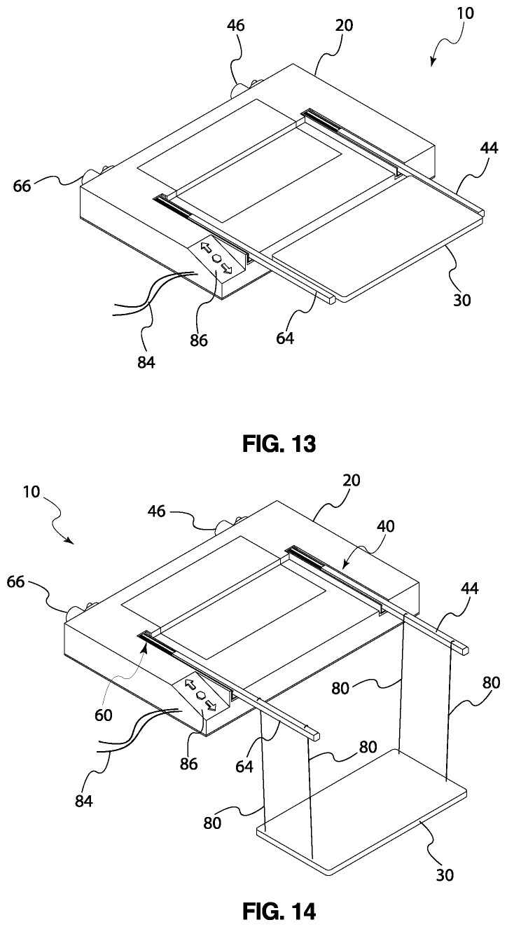

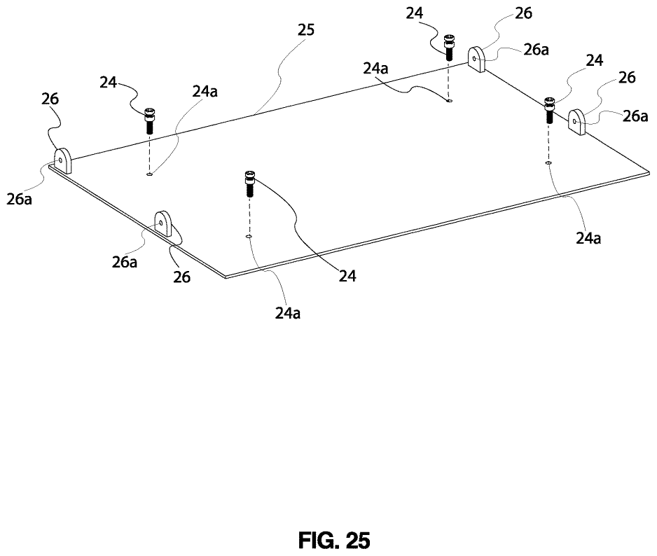

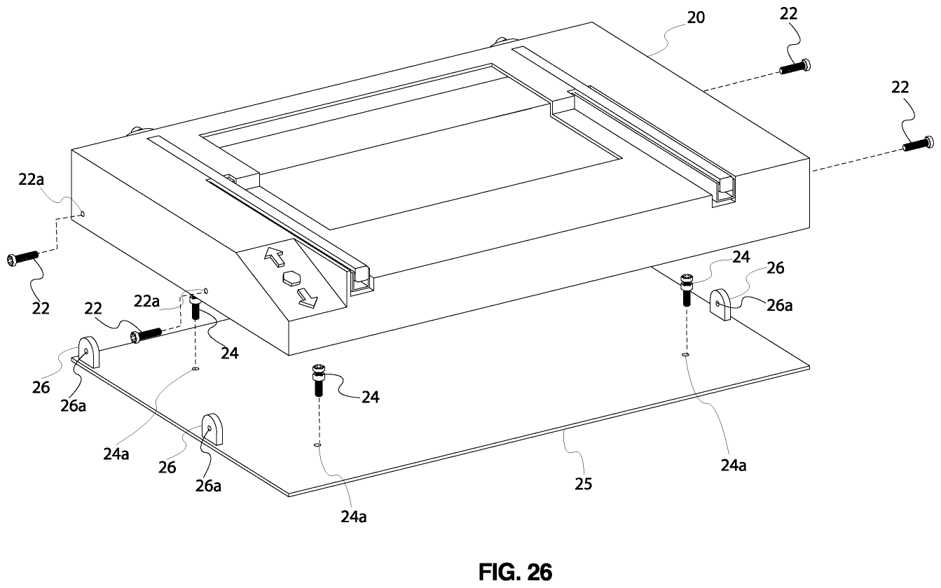

As illustrated in FIGS. 12A, 12B, 21, 25, and 26, the housing 20 is mounted to a bottom cover 25, which serves as a base plate for securing the loading system to the vehicle structure. The housing 20 may be secured to the bottom cover 25 using fasteners 22 that extend through holes 22a formed in the housing and through corresponding holes 26a in connectors 26 associated with the bottom cover. The bottom cover 25 may in turn be secured to structural portions of the automobile trunk compartment using fasteners 24 extending through holes 24a in the bottom cover. This arrangement provides a rigid mounting structure that allows the loading system 10 to be installed within the trunk compartment 92 without requiring substantial modification to the vehicle body.

Referring again to FIGS. 1-6 and 7-11, the loading platform 30 is supported relative to the housing 20 and serves as the surface upon which cargo may be placed. The loading platform 30 may include reinforcing ribs 32 extending along the underside of the platform to increase structural strength and load-bearing capacity.

The loading platform 30 is supported by structural elements associated with the platform moving assemblies located on opposite sides of the platform. In particular, the loading platform may be connected to cross members 82 and 83, which extend between the platform moving assemblies and help maintain alignment of the platform during extension and lowering operations.

The loading system 10 includes two platform moving assemblies (right-side platform moving assembly and left-side platform moving assembly) positioned on opposite sides of the loading platform. These assemblies guide extension and retraction of the loading platform relative to the housing.

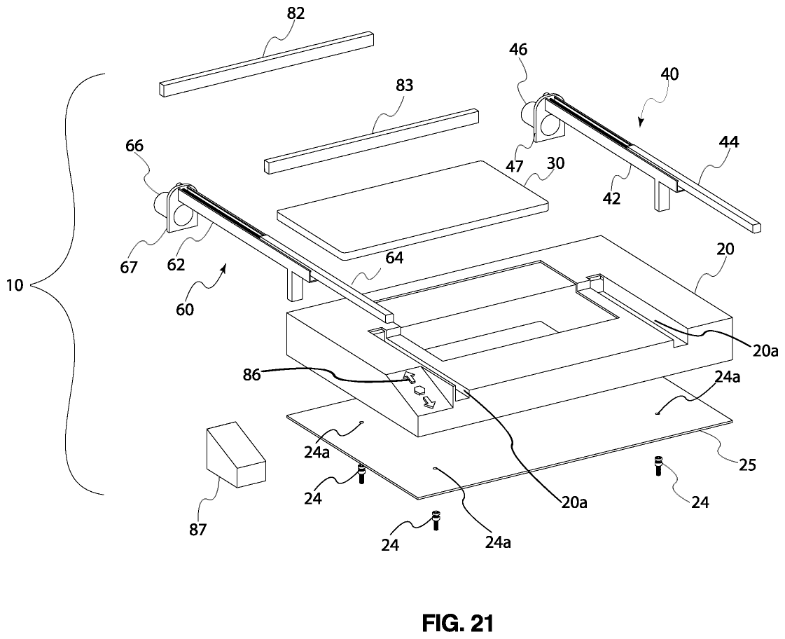

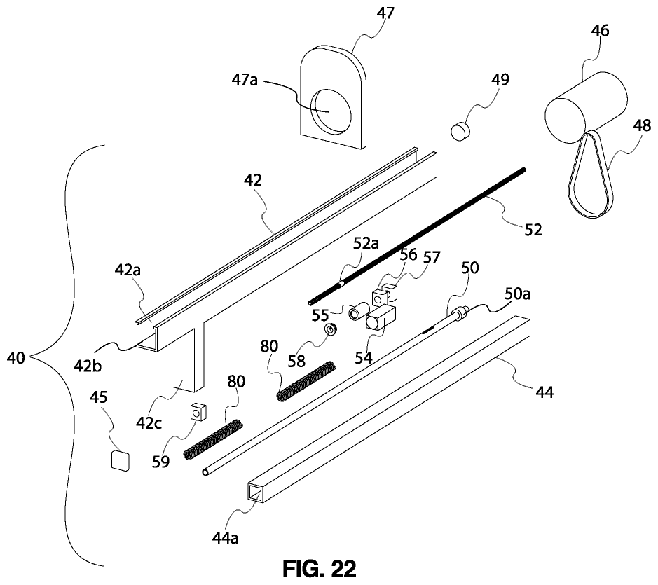

Referring particularly to FIGS. 21 and 22, the right-side platform moving assembly 40 includes a stationary rail 42 and a movable rail 44. The stationary rail 42 is fixed relative to the housing 20 and includes a channel 42a configured to receive and guide movement of the movable rail 44. The stationary rail further includes an open end 42b that allows insertion of the movable rail and a support portion 42c that may rest on structural portions of the housing to maintain alignment.

The movable rail 44 is positioned within the channel 42a of the stationary rail and is configured to slide longitudinally relative to the stationary rail. The open end 44a of the movable rail may be closed by a plug 45 in order to prevent debris or contaminants from entering the interior of the rail.

Movement of the movable rail 44 is driven by a motor 46 mounted to the housing 20 by a mounting bracket 47. The mounting bracket 47 includes an opening 47a through which drive components associated with the motor may extend. As shown in FIG. 22, the motor 46 drives a pulley 49 through a pulley belt 48. The pulley 49 is connected to a sleeve 50, which may include a sleeve flange 50a. The sleeve 50 is coupled to a lead screw 52 that rotates in response to operation of the motor. A thread stop 52a may be provided on the lead screw to limit the travel of associated components.

The right-side platform moving assembly further includes a solenoid clutch mechanism that includes a clutch housing 54, a solenoid coil 55, and a clutch 58. The clutch may selectively engage or disengage the lead screw drive mechanism in response to electrical signals. A plurality of guides, including guide 59, guide 56, and guide 57, are positioned along the assembly to guide cable or wire components associated with lowering the loading platform.

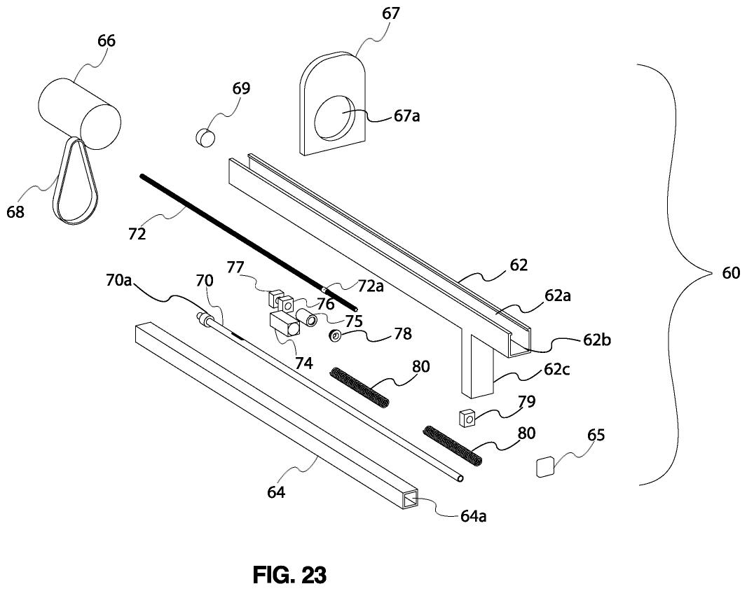

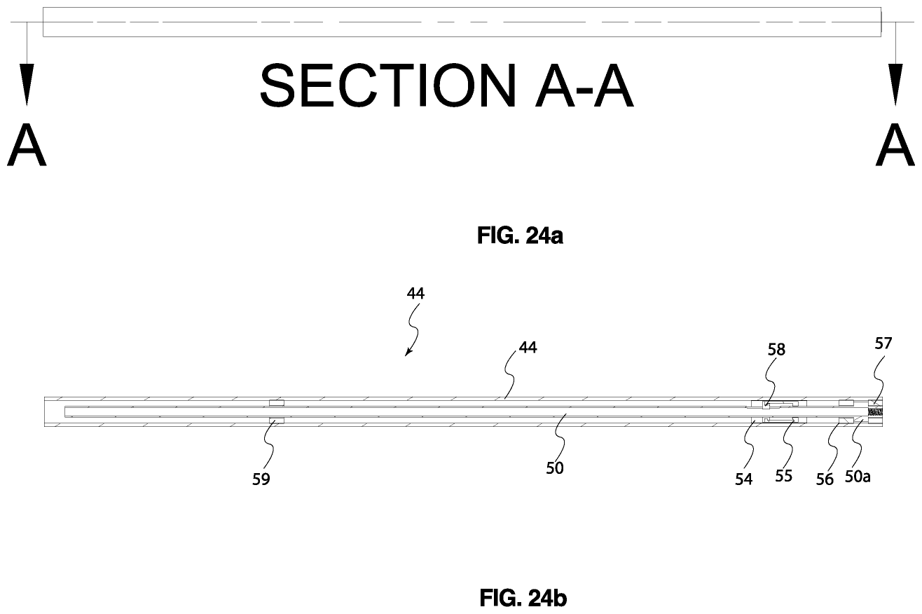

Referring particularly to FIGS. 21 and 23, the left-side platform moving assembly 60 is generally similar to the right-side assembly described above and includes a stationary rail 62 and a movable rail 64. The stationary rail 62 includes a channel 62a, an open end 62b, and a support portion 62c that rests against portions of the housing. The movable rail 64 is positioned within the channel 62a and slides longitudinally relative to the stationary rail. The open end 64a of the movable rail may be closed by a plug 65. The left-side assembly includes a motor 66 mounted to the housing by a mounting bracket 67, which includes an opening 67a. The motor 66 drives a pulley 69 through a pulley belt 68, thereby rotating a sleeve 70. The sleeve 70 may include a bushing 70a and is connected to a lead screw 72. The lead screw may include a washer portion 72a. A solenoid clutch mechanism including solenoid housing 74, solenoid 75, and clutch 78 is provided to control operation of the drive mechanism. Guides 79, 76, and 77 help guide cable components associated with the platform lowering mechanism.

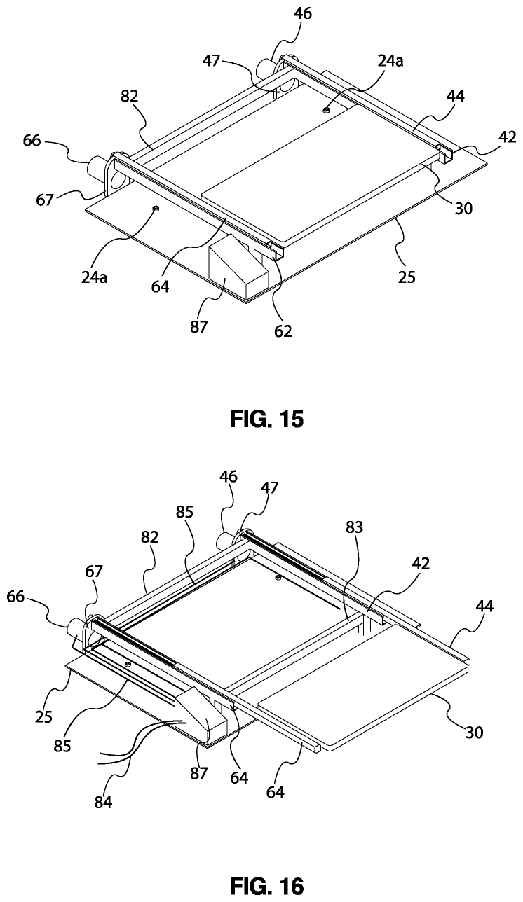

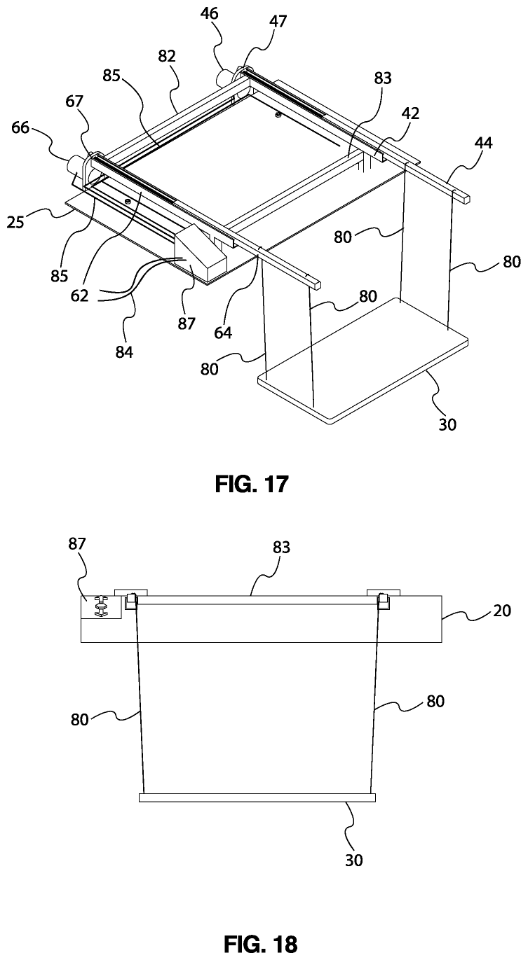

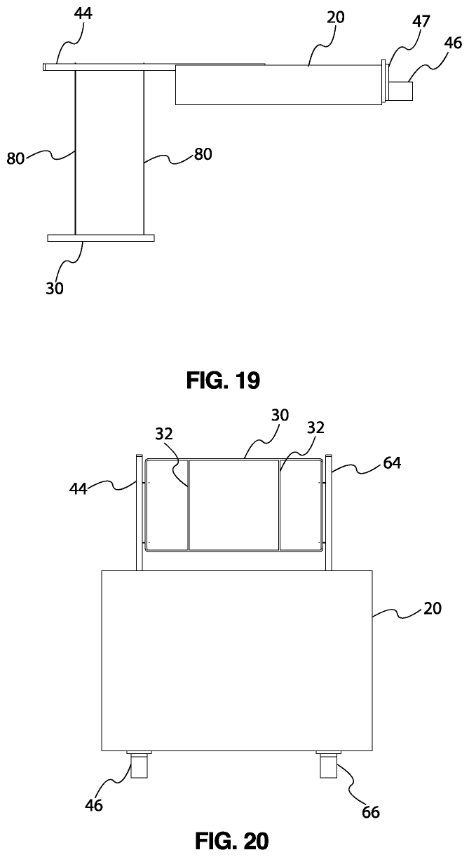

Referring to FIGS. 13-20, the loading system further includes a platform lowering mechanism that allows the loading platform to descend when extended outward from the trunk compartment. The lowering mechanism includes wires or cables 80 that are connected to the loading platform 30 and extend upward through portions of the platform moving assemblies. The wires 80 are wound around the sleeves 50 and 70 associated with lead screws 52 and 72. When the motors 46 and 66 rotate the lead screws, the wires 80 are either wound or unwound around the sleeves. When the wires unwind, the loading platform 30 descends in a controlled manner from the extended configuration to the lowered configuration shown in FIGS. 3, 4, 5, and 14. The cross members 82 and 83 extending between the platform moving assemblies help maintain alignment and support the loading platform during lowering and raising operations.

Referring to FIGS. 12A, 12B, and 21, the loading system includes an electrical system for controlling operation of the motors and associated components. Electrical cables 84 connect the loading system to a power source, such as the vehicle battery or a standalone battery pack. Additional electrical cables 85 connect the motors, solenoids, and other electrical components within the loading system.

A controller 86, which may be mounted on an outer panel of the loading system, allows the user to operate the system. The controller may include switches or buttons for extending, retracting, raising, or lowering the loading platform. An inner control box 87 may contain electrical circuitry for controlling operation of the motors and clutch mechanisms and for distributing electrical power to the various components of the system.

The loading system 10 operates in three primary configurations as illustrated in FIGS. 1-3. In the first configuration, shown in FIGS. 1 and 7-11, the loading platform 30 is positioned within the trunk compartment 92 of the automobile 90 and supported by the housing 20. In this configuration, the movable rails 44 and 64 are positioned within the stationary rails 42 and 62, respectively, and the wires or cables 80 associated with the platform lowering mechanism are wound around the sleeves 50 and 70.

Operation of the loading system may be initiated by a user through the controller 86, which may include push-button controls such as a down arrow control for extending and lowering the loading platform and an up arrow control for raising and retracting the platform. When the user presses the down arrow control, electrical signals are transmitted through cables 85 from the controller 86 to the motors 46 and 66, causing the motors to begin rotating.

As best seen in FIGS. 22 and 23, each motor drives a corresponding pulley 49, 69 via pulley belts 48, 68. Rotation of the pulleys causes rotation of the sleeves 50 and 70, which are connected to lead screws 52 and 72. During the initial stage of operation, rotation of the lead screws causes the sleeves to translate forward along the lead screws. This forward translation pushes the movable rails 44 and 64 outward relative to the stationary rails 42 and 62. Because the loading platform 30 is supported by the movable rails and associated cross members 82 and 83, this motion causes the loading platform to extend outward from the trunk compartment toward the rear of the vehicle. The loading platform thereby moves from the stored configuration shown in FIG. 1 to the extended configuration shown in FIG. 2.

Extension of the movable rails continues until the movable rails reach a maximum outward position. At this position, the thread stop 52a associated with the lead screws prevents further translation of the sleeves along the lead screws. When this maximum extension position is reached, the sleeves 50 and 70 cease translating along the lead screws and instead rotate relative to the lead screws as the motors continue to operate.

Continued rotation of the sleeves causes the wires 80, which are wound around the sleeves, to begin unwinding. The wires pass through guides 56, 57, 59, 76, 77, and 79, which help maintain alignment of the cables and prevent tangling or interference with other components of the platform moving assemblies. As the wires unwind from the sleeves, the loading platform 30 begins to descend in a controlled manner under the influence of gravity and the cable mechanism. The loading platform thereby moves downward to the third configuration illustrated in FIGS. 3-6, in which the loading platform is positioned below the trunk opening.

In this lowered position, the loading platform 30 is positioned at a convenient loading height relative to the ground surface behind the vehicle. This configuration allows a user to place luggage or other cargo onto the loading platform without lifting the cargo over the trunk edge. The reinforcing ribs 32 and cross members 82 and 83 provide structural support to ensure that the loading platform remains stable while cargo is placed onto the platform.

After cargo has been placed on the loading platform 30, the user may press the up arrow control on the controller 86 to raise the loading platform. In response to this command, electrical signals activate the solenoid clutch mechanisms associated with the platform moving assemblies.

As best illustrated in FIGS. 22 and 23, the right-side assembly includes a clutch 58 housed within clutch housing 54 and actuated by solenoid coil 55, while the left-side assembly includes clutch 78 within housing 74 actuated by solenoid 75. Engagement of these clutch mechanisms couples rotation of the motors 46 and 66 to the sleeves 50 and 70 so that the sleeves rotate in the opposite direction. Rotation of the sleeves in the opposite direction causes the wires 80 to wind onto the sleeves, thereby pulling the loading platform 30 upward toward the trunk opening. The guides associated with the cable mechanism maintain proper alignment of the wires as the platform is raised.

Once the loading platform reaches its fully raised position adjacent the trunk opening, the clutch mechanisms disengage so that further rotation of the sleeves is prevented. Continued rotation of the lead screws then causes the sleeves to translate inward along the lead screws. This inward translation pulls the movable rails 44 and 64 back into the stationary rails 42 and 62, thereby retracting the loading platform 30 into the housing 20 within the trunk compartment.

The loading platform ultimately returns to the stored configuration shown in FIG. 1, with the cargo positioned inside the trunk compartment 92. In this configuration the movable rails are fully retracted and the loading system 10 occupies a compact footprint within the trunk compartment, allowing the trunk lid to be closed normally.

In certain embodiments, the controller 86 and associated circuitry within the inner control box 87 may include control logic for monitoring the operational state of the loading system. For example, the control system may monitor the position of the lead screws, rotation of the motors, or electrical load on the motors to determine when the platform has reached its maximum extension or maximum raised position. The control system may also prevent simultaneous conflicting commands and may automatically stop motor operation if abnormal resistance or obstruction is detected, thereby enhancing operational safety and reliability of the loading system.

While the foregoing description illustrates a preferred embodiment of the loading system, it will be understood that the invention may be implemented in various alternative configurations without departing from the scope of the invention.

In one alternative embodiment, the stationary rails and movable rails described above may be replaced with a multi-stage telescoping rail system. In such an embodiment, the loading platform may be supported by a series of nested telescoping rails that extend outward from the housing in successive stages. Each rail stage may include bearing elements or rollers that allow smooth extension and retraction of the loading platform. The telescoping rails may be driven by one or more electric motors connected to lead screws, rack-and-pinion drives, or belt-driven mechanisms. The telescoping configuration may permit the loading platform to extend a greater distance from the trunk compartment while maintaining a compact stored configuration inside the housing.

In another embodiment, the loading system may utilize a single motor rather than separate motors for each platform moving assembly. In this configuration, a central drive shaft or transverse drive mechanism may connect the left and right platform moving assemblies. The motor may drive the central shaft, which in turn may rotate lead screws positioned within each sliding assembly. This arrangement may provide synchronized movement of the movable rails on both sides of the loading platform and may reduce the number of electrical components required for operation of the loading system.

In a further embodiment, the platform lowering mechanism may utilize a hydraulic or pneumatic lifting system rather than cable-driven lead screws. For example, one or more hydraulic cylinders may be connected between the housing and the loading platform. Extension of the hydraulic cylinders may lower the platform when the platform has been extended outward from the trunk compartment. Similarly, pneumatic actuators may be used to raise and lower the platform using compressed air supplied by an onboard or external compressor. Such hydraulic or pneumatic embodiments may provide increased lifting capacity for heavier cargo loads.

In another embodiment, the loading platform may be supported by a scissor lift mechanism. In this configuration, the platform may be mounted on a pair of intersecting scissor arms positioned beneath the platform. The scissor arms may be driven by a lead screw, hydraulic cylinder, or linear actuator to raise and lower the platform relative to the housing. The scissor lift arrangement may provide increased vertical travel of the platform while maintaining

Although the preferred embodiment uses electric motors and electrical control systems, the loading system may also be configured for manual operation. In such embodiments, the movable rails may be extended manually by pulling the loading platform outward from the trunk compartment. A manual crank mechanism may be connected to the lead screws to raise or lower the loading platform. Alternatively, a counterbalanced cable system may be used to assist in lifting and lowering the platform. Manual embodiments may be desirable for vehicles that do not have sufficient electrical capacity to power the loading system.

In another embodiment, the loading platform may be detachable from the platform moving assemblies. The loading platform may include mounting brackets that engage the movable rails using removable fasteners or quick-release locking mechanisms. This configuration may allow the loading platform to be removed from the vehicle for use as a portable work surface or cargo tray.

In another embodiment, the loading system may include an integrated rechargeable battery pack mounted within the housing. The battery pack may power the motors and electrical components of the loading system without requiring connection to the vehicle battery. This arrangement may simplify installation and may allow the loading system to be used in vehicles where direct electrical integration is not desirable.

In another embodiment, the controller may include wireless communication circuitry that allows the loading system to be operated using a remote control device. The remote control may allow the user to extend, retract, raise, or lower the loading platform while standing outside the vehicle. This feature may be particularly advantageous when loading large or heavy cargo items.

In some embodiments, the loading system may include sensors configured to detect obstructions during operation of the loading platform. Such sensors may include position sensors, load sensors, or proximity sensors that detect objects or body parts located beneath the platform. If an obstruction is detected, the control system may automatically stop or reverse operation of the loading system to prevent injury or damage.

Without departing from the spirit and scope of the invention, it will be understood that the various components of the devices, assemblies, and systems according to the present disclosure described herein may be fabricated from any materials suitable for achieving the intended structural strength, durability, and functional performance of the loading system. By way of example, suitable materials may include metals such as steel, stainless steel, aluminum, and aluminum alloys, as well as polymeric materials including engineering plastics, reinforced plastics, and composite materials. In certain embodiments, combinations of metallic and polymeric materials may be used for different components of the system depending on the required load-bearing characteristics, weight considerations, and environmental resistance.

Structural components of the loading system, including the housing, stationary rails, movable rails, support cross members, mounting brackets, and bottom cover, may be fabricated from high-strength metals such as steel or aluminum alloys in order to provide sufficient rigidity and load-bearing capability. These components may be manufactured using fabrication techniques including sheet metal forming, stamping, bending, extrusion, machining, or welding. For example, the stationary and movable rails may be formed from extruded aluminum profiles or roll-formed steel channels configured to provide smooth sliding engagement and structural support for the loading platform.

The loading platform itself may be fabricated from a rigid metallic panel, such as an aluminum plate or formed steel panel, optionally reinforced by ribs or structural members to increase strength while minimizing weight. In certain embodiments, the loading platform may include reinforcing ribs, stamped structural features, or welded reinforcement members positioned on the underside of the platform. The upper surface of the platform may include a non-slip covering such as rubberized material, textured polymer coating, or carpeting to prevent cargo from sliding during operation.

Components associated with the drive and motion assemblies, including the lead screws, sleeves, pulleys, shafts, and clutch components, may be fabricated from hardened steel, stainless steel, or other wear-resistant metallic materials. Lead screws may be formed by precision machining, thread rolling, or grinding processes to ensure accurate engagement with associated components and smooth mechanical operation. Bearings, bushings, or low-friction liners may be incorporated into these components to reduce wear and improve operational efficiency.

Cable or wire elements used in the lowering mechanism may be fabricated from braided steel cable, stainless steel wire rope, or other high-strength flexible tension members capable of supporting the load applied by the loading platform and cargo. These cables may be routed through guide elements or pulleys fabricated from metal or durable polymer materials designed to minimize friction and wear.

Certain non-structural or protective components, including cable guides, electrical housings, controller panels, and protective covers, may be fabricated from molded polymeric materials such as nylon, polycarbonate, polypropylene, ABS, or other engineering plastics. These materials may be produced through injection molding, compression molding, or additive manufacturing processes and may provide advantages such as corrosion resistance, reduced weight, and electrical insulation.

Electrical components of the loading system, including motors, wiring harnesses, controllers, and sensors, may be commercially available automotive-grade components designed to operate within the electrical system of the vehicle. Electrical wiring may be routed through protective sheathing or conduits and secured to the housing or structural components of the loading system to prevent interference with moving mechanical components.

Surface finishing techniques may also be applied to various components to improve corrosion resistance, durability, and aesthetic appearance. For example, metallic components may be treated by anodizing, powder coating, electroplating, galvanizing, or painting. Such treatments may protect the system from environmental exposure including moisture, road debris, and temperature variations encountered during normal vehicle operation.

It will therefore be understood that the particular materials and fabrication methods described herein are provided for illustrative purposes only, and that alternative materials, manufacturing techniques, and structural configurations may be employed without departing from the scope of the present invention.

In certain embodiments, the loading system 10 may be configured as an original equipment manufacturer (OEM) system adapted for factory installation during vehicle assembly. In such embodiments, the housing 20, loading platform 30, platform moving assemblies 40, 60, controller 86, and associated electrical components may be integrated into the trunk compartment 92 as part of the original vehicle structure. The loading system may be mounted beneath or flush with a trunk floor panel, rear cargo floor, or other structural portion of the vehicle, and may be electrically connected to the vehicle electrical system, including the vehicle battery, control modules, and user-interface components. In some factory-installed embodiments, the loading system may be coordinated with other vehicle features, such as trunk lid controls, key fob controls, dashboard controls, vehicle display screens, or safety interlock systems, thereby providing a fully integrated cargo-handling system as part of the vehicle.

In other embodiments, the loading system 10 may be configured and sold as an aftermarket or retrofit mechanism adapted for installation in an existing vehicle after manufacture. In such embodiments, the loading system may be provided as a kit or assembly including the housing 20, loading platform 30, mounting structure, controller 86, wiring, and associated hardware for installation within the trunk compartment of a compatible vehicle. The aftermarket configuration may be adapted to be secured to existing structural portions of the trunk compartment, such as the trunk floor, side walls, frame members, or other support regions, with minimal modification to the vehicle. In certain embodiments, the loading system may be electrically connected to the existing vehicle battery, accessory power system, or an independent battery pack. This retrofit arrangement allows the loading system to be added to vehicles already in service, thereby expanding accessibility and convenience without requiring manufacture of the vehicle with the loading system preinstalled.

The cargo loading system described herein provides numerous advantages over conventional cargo handling methods and previously proposed vehicle loading devices.

First, the system significantly reduces the physical effort required to load heavy luggage or cargo into a vehicle. By automatically lowering a loading platform to a position near ground level and subsequently raising the platform to the level of the trunk compartment, the system eliminates the need for users to lift heavy objects over the trunk threshold.

Another advantage is the improved accessibility provided by the system. Because the loading platform can descend to a low position outside the vehicle, users can easily slide or place luggage onto the platform without bending excessively or lifting the cargo to waist height. This is particularly beneficial for elderly individuals, travelers handling heavy suitcases, and users with limited strength or mobility.

The system also provides improved safety. By minimizing heavy lifting and awkward body positions, the risk of back strain, muscle injury, or accidental dropping of cargo is reduced. In addition, the system may incorporate sensors and control logic to detect obstacles, monitor load weight, and prevent unsafe operation, thereby enhancing user safety during operation.

Another advantage is the integrated and concealed design of the system. The loading mechanism can be built into the trunk floor, rear bumper area, or another compartment within the cargo space so that it remains hidden when not in use. This allows the vehicle to maintain normal cargo capacity and preserves the aesthetic appearance of the trunk area.

The system further provides convenience and ease of use. Operation may be initiated by a push button, remote control, or other user interface, enabling automated deployment, lifting, and retraction of the loading platform. The user therefore does not need to manually manipulate complex mechanisms or perform heavy lifting tasks.

Additional advantages include versatility and adaptability across different vehicle types. The loading system may be configured for use in sedans, sport utility vehicles, vans, or other vehicles with cargo compartments. The system may also be implemented in multiple configurations, such as a platform-type lift or an articulated arm arrangement, depending on the packaging constraints and intended cargo capacity of the vehicle.

The system can also enhance the overall user experience by enabling efficient loading and unloading of luggage while maintaining vehicle functionality and safety. By integrating powered lifting, extension, and transfer mechanisms into the vehicle structure, the invention provides a practical and user-friendly solution for automated cargo handling.

The foregoing description of the present invention is provided to enable any person skilled in the art to make and use the invention. Various modifications and variations will be readily apparent to those skilled in the art, and the generic principles described herein may be applied to other embodiments without departing from the spirit and scope of the invention. Accordingly, the invention is not intended to be limited to the embodiments described herein but is to be accorded the full scope consistent with the appended claims and their equivalents.

What is claimed is:

1. A loading system for a vehicle trunk compartment comprising:
a housing configured for installation within a trunk compartment of a vehicle;
a loading platform supported by the housing;
a first platform moving assembly including a stationary rail and a movable rail;
a second platform moving assembly including a stationary rail and a movable rail;
at least one motor configured to move the movable rails relative to the stationary rails to extend the loading platform outward from the housing; and
a lowering mechanism including a cable connected to the loading platform and driven by a lead screw configured to lower the loading platform outside the trunk compartment.

2. The loading system of claim 1, wherein the lowering mechanism includes wires wound around the lead screws.

3. The loading system of claim 1, wherein each platform moving assembly includes a pulley and belt system connecting the motor to the lead screw.

4. The loading system of claim 1, wherein the platform moving assemblies are positioned on opposite sides of the loading platform.

5. The loading system of claim 1, wherein the lowering mechanism includes a solenoid-actuated clutch.

6. The loading system of claim 1, wherein the movable rails slide within channels of the stationary rails.

7. The loading system of claim 1, further comprising a controller configured to control extension and lowering of the loading platform.

8. The loading system of claim 1, wherein the housing is mounted to a bottom cover attached to the vehicle trunk structure.

9. The loading system of claim 1, wherein the lowering mechanism includes cables guided through guide elements positioned along the platform moving assemblies.

10. The loading system of claim 1, wherein the loading platform is supported by cross members extending between the movable rails.

11. The loading system of claim 1, wherein the lowering mechanism allows controlled descent of the loading platform.

12. The loading system of claim 1, wherein the loading platform is lowered to a position below the trunk opening.

13. A loading system for a vehicle trunk compartment comprising:
a housing configured for installation within a trunk compartment of a vehicle;
a loading platform supported relative to the housing;
a pair of platform moving assemblies positioned on opposite sides of the loading platform, each platform moving assembly including:
a stationary rail secured relative to the housing; and
a movable rail configured to slide relative to the stationary rail;
at least one motor configured to drive extension of the movable rails to move the loading platform outward from the trunk compartment; and
a vertically adjustable support mechanism connected to the loading platform and configured to lower the loading platform to a position outside and below an opening of the trunk compartment,
wherein the loading platform is movable between:
a stored configuration inside the trunk compartment,
an extended configuration outside the trunk compartment, and
a lowered configuration positioned below the trunk opening for loading cargo.

14. The loading system of claim 13, wherein each of the platform moving assemblies further comprises a lead screw operatively driven by the at least one motor, a sleeve coupled to the lead screw, and at least one cable connected to the loading platform and wound around the sleeve, rotation of the lead screw causing the cable to wind or unwind so as to raise or lower the loading platform relative to the housing.

15. The loading system of claim 13, wherein the stationary rail of each platform moving assembly includes a longitudinal channel configured to receive the movable rail, and wherein the movable rail is guided within the channel for sliding movement between a retracted position corresponding to the stored configuration of the loading platform and an extended position corresponding to the extended configuration of the loading platform.

16. A method for loading cargo into a vehicle trunk compartment comprising:
extending a loading platform outward from a housing installed within a trunk compartment of a vehicle;
lowering the loading platform from the extended position to a position outside and below the trunk opening;
placing cargo onto the loading platform;
raising the loading platform; and
retracting the loading platform into the trunk compartment.

17. The method of claim 16, wherein the loading platform is extended by sliding movable rails relative to stationary rails.

18. The method of claim 16, wherein the loading platform is lowered using a cable-driven lead screw mechanism.

19. The method of claim 16, further comprising operating electric motors to extend and retract the loading platform.

20. The method of claim 16, further comprising controlling operation of the loading platform using a controller mounted to the loading system.
